(19) United States
(12) Patent Application Publication
(10) Pub. No.: US 2024/0226972 A1
(43) Pub. Date: Jul. 11, 2024

(54) IMPROVED ANTI-BIOFOULING SYSTEM

(71) Applicants: COMMISSARIAT A L'ENERGIE ATOMIQUE ET AUX ENERGIES ALTERNATIVES, Paris (FR); UNIVERSITÉ DE TOULON, La Garde (FR)

(72) Inventors: Lucas GRILLI, Grenoble Cedex 09 (FR); Christine BRESSY, Ollioules (FR); Hugues BRISSET, Saint-Cyr-Sur-Mer (FR); Fabrice CASSET, Grenoble Cedex 09 (FR)

(73) Assignees: COMMISSARIAT A L'ENERGIE ATOMIQUE ET AUX ENERGIES ALTERNATIVES, Paris (FR); UNIVERSITÉ DE TOULON, La Garde (FR)

(21) Appl. No.: 18/580,945

(22) PCT Filed: Jul. 18, 2022
(86) PCT No.: PCT/FR2022/051426

§ 371 Date: Jan. 19, 2024

(30) Foreign Application Priority Data
Jul. 21, 2021 (FR) FR2107857

(51) Int. Cl. B08B 17/06; B08B 7/02; B82Y 15/00; G01N 17/00

(52) U.S. Cl. CPC B08B 17/065; B08B 7/02; G01N 17/008; B82Y 15/00

(57) ABSTRACT

An anti-biofouling system for attaching to a device which comprises a fouling-sensitive element and which is configured to be immersed in a liquid and at least partially cover the fouling-sensitive element. The anti-biofouling system comprises a plate which extends in a plane XY and has two opposite main faces, one of which is intended to be in contact with the liquid. The anti-biofouling system also includes at least one actuator located on one of the main faces of the plate and able to deform the plate off its plane. The plate has a nano-texture over all or part of the face intended to be in contact with the liquid. The nano-texture is formed by a plurality of elements raised with respect to a surface of the plate, each raised element having at least two dimensions of 1 nm to 1,000 nm. On at least one area of the nano-textured face the raised elements are spaced apart from one another by a distance of 1 nm to 1,000 nm.

### TECHNICAL FIELD

The field of the invention is that of so-called “anti-fouling” systems (according to an anglicism which could translate into French as anti-biofouling) intended to equip immersed devices, in particular sensors and measuring probes.

### PRIOR ART

Currently, numerous devices for controlling the marine environment are present in all oceans and seas of the planet. These control devices are often implemented on already existing structures, such as offshore platforms or ships, but may also be part of dedicated oceanographic stations.

Control devices are also used for controlling the supply networks of drinking water and for controlling river water.

In general, these control devices consist of sensors or measuring probes and allow monitoring a wide variety of parameters like, for example, the dissolved oxygen level, the turbidity, the conductivity, the pH, the fluorescence, etc.

Yet, any surface immersed in a liquid, and in particular in seawater, is subject to the deposition and adhesion of organisms which may be bacteria, algae, molluscs, etc.

This phenomenon is known as “biofouling” or biological fouling. When the environmental conditions are met, the adhesion of microorganisms on the surface of an immersed material and their multiplication leads to the formation of a film, so-called “biofilm”, at the surface of the material.

The presence of this biofilm at the surface of a material is problematic, since it will modify the technical characteristics of the material, causing, for example, a reduction in the optical or mechanical properties of the material, an acceleration of corrosion thereof, etc.

Thus, the quality of the measurements made by the control devices might be affected by biofouling at their surface after only a few days. This is why anti-fouling solutions are necessary in order to obtain a constant quality of data and to reduce the maintenance necessary for cleaning thereof.

In practice, on the control devices present on the market, biofouling protection is rarely taken into account by the manufacturers, the used materials and their geometries being primarily designed for the technical aspects related to the measurement, or the economic aspects related to the production costs. Anti-fouling solutions are then added by the users, which turn towards the currently available commercial solutions.

At the present time, the anti-fouling solutions are declined into two main categories: the chemical solutions and the mechanical solutions.

The chemical solutions consist in applying, on the surface to be protected, a coating loaded with biocides. The toxicity of the biocides contained in the coating allows repelling and destroying the microorganisms.

There are also so-called “FRC” coatings (standing for “Fouling Release Coatings” in English, which could be translated as “anti-fouling coatings”), which are intended to cover any sensitive surface of the control device intended to be in contact with the fouling liquid. These FRC coatings are polymers whose formulation allows minimising the adhesion forces between the biofilm and the covered surface. This allows easily removing the biofilm off the covered surface, simply with the movement of the water against the surface if the speed is sufficient, or by rapid cleaning.

On the other hand, there are mechanical solutions, which may be preventive or corrective.

As regards the mechanical prevention of biofouling, it is possible for example to install a shutter on the sensitive surface, which will physically protect the sensitive surface and which will only open when the measurement reading is in progress.

To mechanically remove the biofouling, it is possible, for example, to install remote wipers which, by passing in contact with the sensitive surface, will remove the microorganisms present on the sensitive surface.

But the conventional technologies rapidly show their limits.

The chemical coatings are polluting and release biocides until exhaustion thereof, thereby becoming ineffective.

FRC coatings are useful on ships navigating on a regular basis and at sufficient speeds, but they are unsuitable for protecting immersed probes from biofouling which, for most of them, remain static.

The mechanical solutions, such as offset wipers or mechanical shutters, are themselves sensitive to biofouling and cannot be exploited on the long run without regular maintenance.

New technologies are today in development to provide solutions that are more efficient than those mentioned before. Among these new technologies, mention may be made of those using vibrations to promote the detachment of marine bacteria, which seem to be promising.

Mention may in particular be made of a technology using piezoelectric films made of PolyVinylidene Fluoride (PVDF), which is in development for the protection of the sensitive surfaces of immersed optical probes (document [1]). This technology consists in bonding the PVDF film onto a thin glass plate representing the optical window of an oceanographic sensor. The PVDF film is an actuator which makes the glass plate vibrate, thereby conferring a biofouling resistance thereon by peeling off the microorganisms trying to proliferate or by preventing adhesion thereof.

Mention may also be made of recent searches which have demonstrated the bactericidal and/or anti-fouling activity of surfaces nano-textured with nano-pillars (document [2]). When the nano-pillars are small enough compared to the bacteria, they can pierce their membrane, killing them (bactericidal effect) and thus preventing the formation of biofouling on the nano-textured surface. Conversely, when the pillars are relatively large with respect to the bacteria, they will reduce the surface area available for the adhesion of the bacteria. Indeed, the bacteria have, at the surface, “feet” which may be curli, pili or flagella, which allow the bacteria to adhere to the surfaces. When the surface is nano-textured by relatively large nano-pillars compared to the bacteria, the surface available for the bacteria is reduced, therefore these adhere less to this type of surface (anti-fouling effect). Thus, nano-texturing reduces biofouling, but nevertheless does not completely prevent it. Hence, its efficiency is limited.

### DISCLOSURE OF THE INVENTION

An objective of the invention is to provide an anti-fouling system that is more effective than those of the prior art.

To this end, the invention provides an anti-biofouling system intended to be attached on a device which comprises a fouling-sensitive element and which is intended to be immersed in a liquid, the system being configured to at least partially cover the fouling-sensitive element,
the system being characterised in that it comprises:
a plate, extending in a plane XY and having two opposite main faces, one of which is intended to be in contact with the liquid; and
at least one actuator, able to deform the plate off its plane, and located on one of the main faces of the plate;
the plate including a nano-texture, over all or part of the face intended to be in contact with the liquid, this nano-texture being formed by a plurality of elements raised with respect to a surface of the plate, each raised element having at least two dimensions out of three which are comprised between 1 nm inclusive and 1,000 nm exclusive, and the raised elements being, at least over an area of the nano-textured face, spaced apart from each other by a distance comprised between 1 nm inclusive and 1,000 nm exclusive.

“Fouling-sensitive element” refers to an element which is likely to be fouled when it is in contact with a liquid and the operation of which will be altered by this fouling. If the device is an optical sensor, the fouling-sensitive element may be an optical window of the sensor.

Preferably, all raised elements are spaced apart from one another by a distance comprised between 1 nm inclusive and 1,000 nm exclusive.

In the context of the present invention, by “nano-texture”, it should be understood a surface structuring formed by a plurality of raised elements, each raised element having at least two dimensions out of the three dimensions which are nanometric, i.e. larger than or equal to 1 nanometre and smaller than 1,000 nanometres; by “micro-texture”, it should be understood a surface structuring formed by at least one recessed element, said recessed element having at least two dimensions out of the three dimensions which are micrometric, i.e. larger than or equal to 1 micrometre and smaller than 1,000 micrometres.

To measure nanometric or micrometric dimensions, a scanning-electron microscope (SEM) may be used.

Preferably, the raised elements are pillars having a section with dimensions comprised between 1 nm inclusive and 1,000 nm exclusive. This section may be circular, square, rectangular, etc.

Advantageously, the raised elements have at least one dimension larger than or equal to 40 nm inclusive and a spacing between the raised elements larger than or equal to 40 nm inclusive. A spacing of at least 40 nm allows having an anti-fouling and/or bactericidal effect on the smallest bacteria of the marine environment. In practice, the spacing between the raised elements will be most of the time similar to the dimensions of the cross-section of the elements of the nano-texture; for example, elements with a 500 nm cross-section will be spaced apart by 500 nm. Preferably, all of the dimensions of the raised elements are larger than or equal to 40 nm.

The raised elements forming the nano-texture may be distributed uniformly or not over the plate (i.e. the spacing between the raised elements may be uniform or not). They may all be identical or not.

According to one variant, said at least one actuator and the nano-texture are on distinct main faces.

Preferably, the system includes two actuators. But any other number of actuators adapted to the dimensions and to the geometry of the plate could be used to optimise the electromechanical response of the system.

According to one variant, the plate is rectangular and said at least one actuator is arranged parallel to two opposite edges of the plate.

Advantageously, one amongst the two main faces of the plate includes a micro-texture, this micro-texture being formed by at least one element recessed with respect to a surface of the plate, said recessed element having at least two dimensions out of three which are comprised between 1 μm inclusive and 1,000 μm exclusive.

Thus, the micro-texture may be formed on the face comprising the nano-texture or on the opposite face.

The recessed element may be located at any location of the plate or positioned judiciously where there is most stress at the plate, namely at the points of attachment of the plate to the sensitive element of the device or at the points of inflection of the plate, in order to soften it and promote the amplitude of deformation.

The actuator(s) is/are adapted to generate vibrations at the plate. Preferably, said at least one actuator is a piezoelectric actuator.

According to one variant, the face of the plate including the nano-texture and the raised elements are coated with a chemical coating having anti-fouling properties.

The invention also relates to an assembly including a device having a fouling-sensitive element and an anti-biofouling system as described hereinabove, the system being attached on the device so as to at least partially cover the fouling-sensitive element, and wherein the device is a sensor-type control device. For example, if the device is an optical sensor (for example an optical probe), the anti-fouling system may be arranged overhanging the optical window of the sensor. It is possible to leave a space of a few hundred micrometres or a few millimetres between the face of the optical window and the plate; but it is also possible to choose to press the plate directly against the face of the optical window. If a space is left, this space will be closed in order to prevent the liquid from coming into contact with the surface to be protected. Preferably, the plate will be fastened over its entire periphery to prevent the fouling liquid from coming into contact with the surface to be protected.

### BRIEF DESCRIPTION OF THE DRAWINGS

Other aspects, aims, advantages and features of the invention will appear better upon reading the following detailed description of preferred embodiments thereof, given as a non-limiting example, and made with reference to the appended drawings wherein:

FIG. 1a is a schematic illustration according to a bottom and perspective view of an embodiment of the anti-fouling system according to the invention;

FIG. 1b is a schematic sectional view along the line I-I of Figure la with a large plane showing the nano-texture present at the surface;

FIG. 2 shows an example of nano-pillars made in a substrate made of silicon and observed with a scanning-electron microscope;

FIG. 3a is a schematic sectional illustration of a first step of an example of manufacture of a nano-textured plate;

FIG. 3b is a schematic sectional illustration of a second step of an example of manufacture of a nano-textured plate;

FIG. 3c is a schematic sectional illustration of a third step of an example of manufacture of a nano-textured plate;

FIG. 3d is a schematic sectional illustration of a fourth step of an example of manufacture of a nano-textured plate;

FIG. 4a is a schematic sectional illustration of a first step of an example of making actuators on a nano-textured plate;

FIG. 4b is a schematic sectional illustration of a second step of an example of making actuators on a nano-textured plate;

FIG. 4c is a schematic sectional illustration of a third step of an example of making actuators on a nano-textured plate;

FIG. 4d is a schematic sectional illustration of a fourth step of an example of making actuators on a nano-textured plate;

FIG. 4e is a schematic sectional illustration of a fourth step of an example of making actuators on a nano-textured plate;

FIG. 4f is a schematic sectional illustration of a fifth step of an example of making actuators on a nano-textured plate;

FIG. 4g is a schematic sectional illustration of a sixth step of an example of making actuators on a nano-textured plate;

FIG. 4h is a schematic sectional illustration of a seventh step of an example of making actuators on a nano-textured plate;

FIG. 4i is a schematic sectional illustration of an eighth step of an example of making actuators on a nano-textured plate;

FIG. 5 is a schematic sectional view of an embodiment of an anti-fouling system according to the invention, the nano-textured plate of which is actuated in bending;

FIG. 6 is a schematic sectional view of an embodiment of a nano-textured anti-fouling system according to the invention, with zooms on the nano-texture in a central area and in lateral areas;

FIG. 7 is a schematic sectional view of an embodiment of a nano-textured and micro-textured anti-fouling system according to the invention, with zooms on the nano-texture in a central area and in lateral areas.

### DETAILED DISCLOSURE OF PARTICULAR EMBODIMENTS

In the system according to the invention, the action of a vibrating plate is coupled with a nano-texture of this plate. The two vibration and nano-texture effects will not only add together, coupling of the two leading to an increase in the anti-fouling effects of these two solutions considered separately. Indeed, the vibrations will set the nano-texture into movement, thereby improving the bactericidal and anti-fouling effects of the nano-texture.

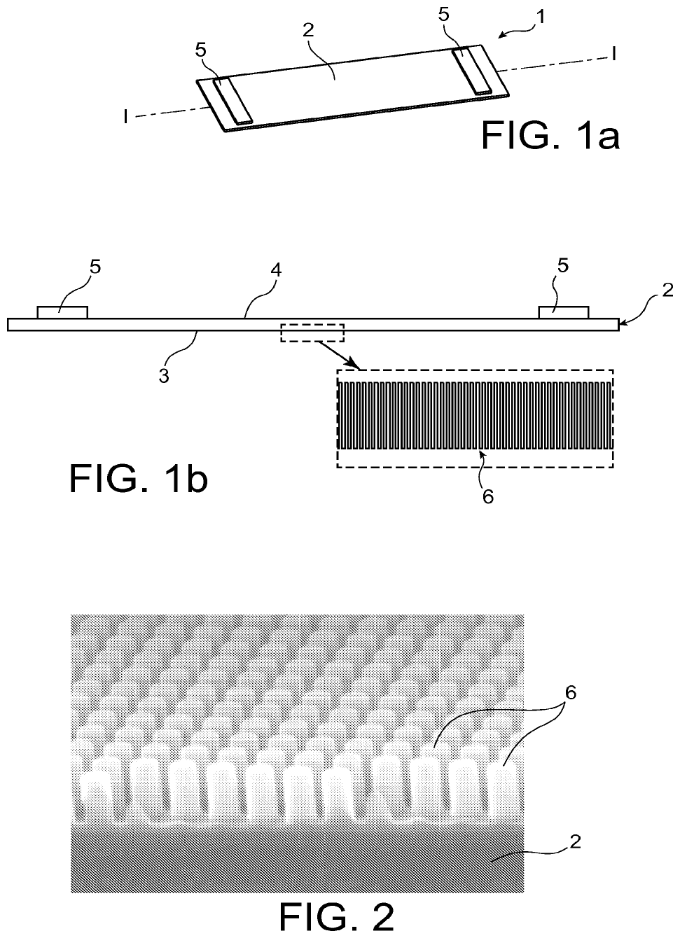

An example of a nano-textured vibrating plate system 1 according to the invention is illustrated in FIGS. 1a and 1b, respectively showing a bottom view of the system 1 and a sectional view according to the line I-I. In this case, the plate 2 is rectangular; it may be made of glass, of a polymer, for example of polydimethylsiloxane (PDMS), of polyethylene naphthalate (PEN), of polycarbonate (PC), etc. In the illustrated embodiment, the lower face 4 includes two actuators 5 (FIG. 1a) which extend parallel to two opposite edges of the plate and the upper face 3 of the plate includes a nano-texture (visible in the zoomed portion).

According to the invention, the nano-texture is formed by a plurality of raised elements 6 having at least two dimensions out of three with nanometric sizes and spaced apart from one another by a nanometric distance. These raised elements 6 may be dispersed homogeneously or not over all or part of a face of the plate. The raised elements may be equidistant or not. They may be identical (same dimensions and same shape) or not. Preferably, the raised elements 6 are distributed over the entire surface of a face of the plate, are equidistant and are identical.

In the embodiment illustrated in FIG. 1b, the nano-texture is in the form of a plurality of pillars with nanometric sizes, identical and spaced apart uniformly on the upper face 3 of the plate 2 by a distance that is also nanometric. For example, these raised elements could also represent a plurality of raised striae arranged in parallel, this configuration being nonetheless less effective than a configuration with a plurality of pillars.

The nano-texture may be located over only part of the surface of the plate or be present over the entirety of the upper face. In particular, the nano-texture may be located only in the field of the sensor to be protected from biofouling. In FIG. 1b, for simplicity, only the pillars in the zoomed area have been shown.

The pillars 6 may have a polygonal (square, rectangular, star-like, etc.) or circular cross-section, as shown in FIG. 2. The cross-section of the pillars having a nanometric size, the pillars are also called nano-pillars.

The dimensions of the nano-pillars may be comprised between a few nanometres, typically 5 nm, up to 1 micrometre exclusive for the length and the width, in the case of nano-pillars with a polygonal cross-section, or for the diameter, in the case of nano-pillars with a circular cross-section; with regards to the height of these nano-pillars, it amounts to at least a few nanometres, typically 5 nm, but it could extend to several tens of millimetres, the maximum height of the height being limited only by the technological limitations of manufacture of the nano-textures.

The nano-texture of the anti-biofouling system according to the invention may be shaped by various techniques. This shaping should lead to a plate 2 having a nano-textured face, and possibly micro-textured, provided with one or more electromechanical actuator(s) 5 isolated from the external environment.

For illustration, we will describe in detail an example of manufacture of an anti-biofouling vibrating system 1 according to the invention. In this example, first of all, it is proceeded with the manufacture of a nano-textured plate 2, and then actuators 5 are attached thereto.

One amongst the possible techniques for making the nano-texture and the possible micro-texture, and that we will use in our embodiment, is nanoimprint lithography (NIL). The NIL technique is a simple, low-cost and repeatable technique for producing micrometric and nanometric patterns on a face of a substrate. For example, this technique may be used to create arrays of nano-pillars made of polydimethylsiloxane (PDMS) over large surfaces (in the range of cm² to several tens cm²).

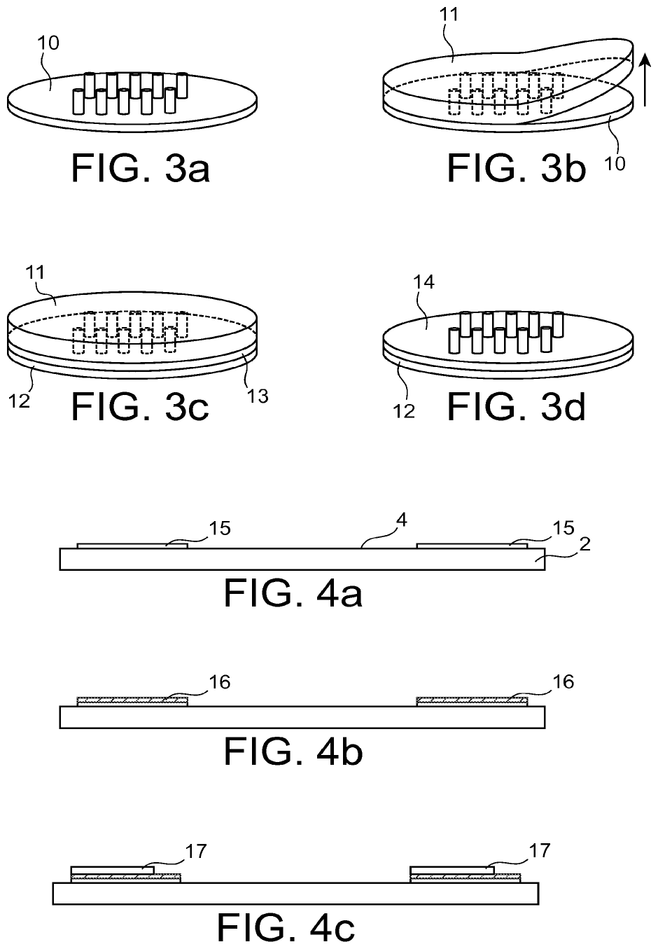

During a first step (FIG. 3a), the face of a model substrate 10 including an array of raised elements (nano-pillars) to be replicated is fluorinated; in this case, the template substrate is made of silicon and a very thin release layer is added to facilitate the manufacture of the mould. This release layer may be obtained by vaporisation of fluorinated molecules over the template substrate. For example, the considered fluorinated molecules may be tridecafluoro-1,1,2,2-tetrahydrooctyltrichlorosilane [CF₃—(CF₂)₅—(CH₂)₂-SiCl₃]. During a second step, the patterns of the textured face of the template substrate 10 are moulded by depositing thereon a layer of PDMS cross-linking under UV light, then the PDMS is exposed to UVs so that it cross-links, and finally the cross-linked PDMS layer 11 is cautiously removed (FIG. 3b). This layer 11 forms a mould including an array of nanocavities which forms the negative imprint of the array of nano-pillars. The mould thus obtained is also covered with a release layer by vaporisation of fluorinated molecules.

In a third step, a support substrate 12 made of silicon is covered with a non-crosslinked PDMS resin layer 13 and the mould 11 is pressed onto the non-crosslinked resin 13 for a few minutes (FIG. 3c). The polymer fills the cavities of the mould. Then, it is proceeded with cross-linking of the resin, forming the crosslinked PDMS resin layer 14.

It should be noted that if the face of the plate 2 should also include a micro-texture (one or more recessed element(s) having micrometric size(s) (element(s) embedded in the face of the plate)), the latter could be made at the same time as the nano-texture, by adding this or these recessed element(s) into the face of the model substrate 10. Alternatively, the micro-texture may be made before or after the nano-texture, on the same face or on the opposite face.

When the resin (layer 14) has cross-linked, the mould (layer 11) is removed and a layer 14 made of PDMS (one face of which is nano-textured by an array of nano-pillars) is then obtained on a support substrate 12 (FIG. 3d).

Finally, it is proceeded with the removal of the support substrate 12 by thinning, until complete disappearance, by attacking the rear face.

The plate 2 is herein made of PDMS, because this material is well-suited to NIL techniques for forming nano-textures using a mould. However, the plate may be made of other materials, as long as it is possible to nano-texture them (glass, plastic, etc.). Of course, since the anti-fouling system is intended to protect immersed optical sensors, the nano-textured and possibly micro-structured plate should also be transparent in the optical field of operation of the optical sensor. If the optical sensor measures in the UV range, then the plate should be transparent to UV to be useful. It should be noted that this embodiment is indicative, and that any other embodiment could be used, using, for example, materials deposited in thin layers by microelectronics technologies, or commercial piezoelectric actuators already fitted with their own electrodes.

Once the plate 2 is nano-textured, it is then proceeded with the attachment of the actuators 5.

The actuators, or electromechanical actuators, are well-known electromechanical conversion means. They may be of various natures, such as magnetic, piezoelectric, electro-active, shape-memory or other types.

Advantageously, they will be piezoelectric (preferably made of ceramic, for example of lead zirconate titanate (PZT), aluminium nitride (AIN), zinc oxide (ZnO), etc.), because this actuation mode ensures good coupling between the actuator and the plate.

In a known manner, an actuator is a stack formed of an active material sandwiched between two electrodes, the whole being preferably covered with a passivation layer.

In our embodiment, two piezoelectric actuators 5 made of a PZT ceramic are made on the face of the plate (lower face 4) that is opposite to that including the nano-texture.

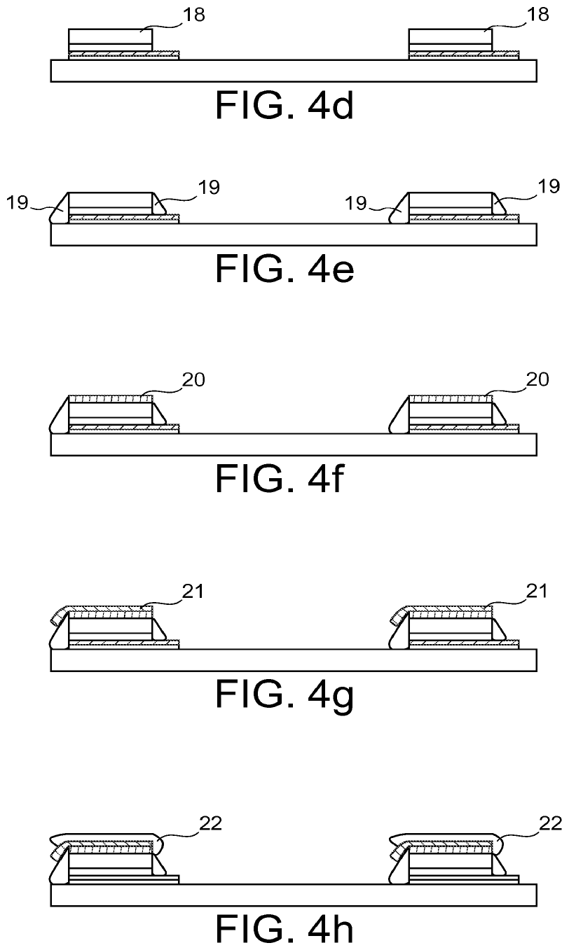

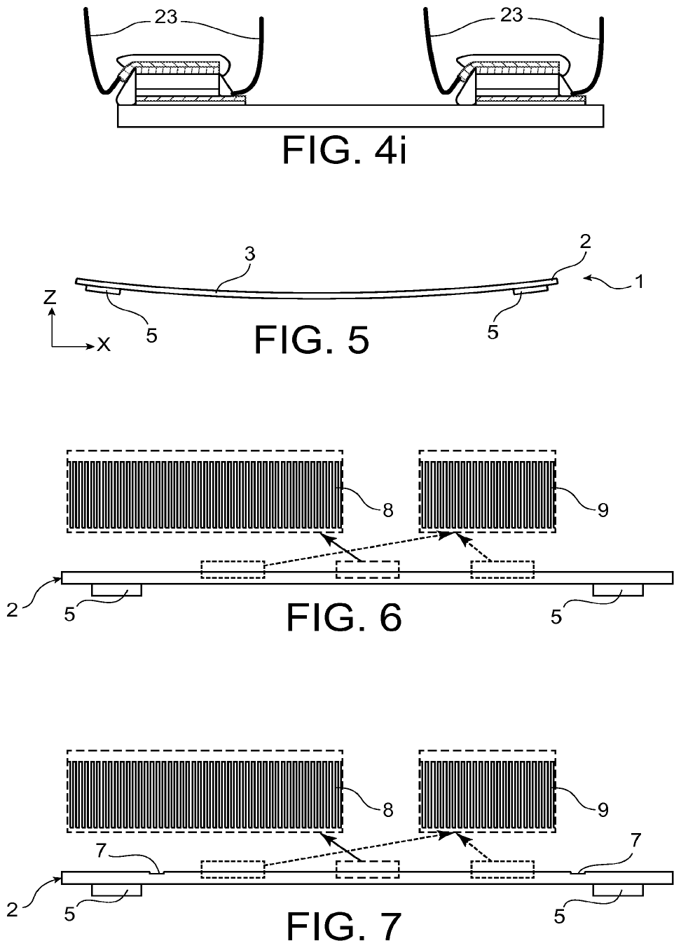

On the lower face 4 of the nano-textured plate 2, a glue layer 15 is deposited at two distant locations marking the location of the future actuators (FIG. 4a); on each of these glue layers 15, a metal layer is deposited, for example made of platinum, to form the lower electrode 16 of the actuator (FIG. 4b); on each lower electrode 16, an adhesive layer 17 (FIG. 4c) is deposited; then, a layer made of piezoelectric ceramic 18 is deposited over each adhesive layer 17 (for example by the “pick and place” handling technique) (FIG. 4d); the lower electrodes are protected by coating the lateral faces of the ceramic with an electrically-insulating material 19 (FIG. 4e); an electrically-conductive glue layer 20 is deposited over the upper face of the layers made of ceramic 18 (FIG. 4f); an electrically-conductive layer is deposited over these conductive glue layers 20, for example of an alloy of gold and ruthenium, to form the upper electrode 21 of the actuator (FIG. 4g); the upper electrode 21 of each actuator is isolated by covering it with a layer of an electrically-insulating material 22 (FIG. 4h); finally, an electrical contact is established with the lower 16 and upper 21 electrodes of each actuator 5, for example via electrically-conductive wires 23 (FIG. 4i) and a nano-textured vibrating system according to the invention is then obtained, which could then be fastened on the sensitive area of an immersed probe to be protected from biofouling. It should be noted that this embodiment is indicative, and that any other embodiment could be used, using, for example, materials deposited in thin layers by microelectronics technologies, or commercial piezoelectric actuators already fitted with their own electrodes.

In a known manner, the application of a potential difference between the upper and lower electrodes of the piezoelectric actuators will induce an electric field outside the plane XY of the plate. By inverse piezoelectric effect, this electric field will involve a deformation in the plane of the plate (piezoelectric coefficient d₃₁) inducing an off-plane deformation of the plate (i.e. in the direction Z), because of the induced mechanical torque and the bimetallic effect.

By applying a DC voltage, the plate will deform up to its equilibrium position. By applying an AC voltage, we will be able to make the plate vibrate, for example at the resonance frequencies of its different eigenmodes.

The system 1 according to the invention, which has been illustrated at rest in FIG. 1b, is shown with its plate 2 deformed in bending in the direction Z− in FIG. 5.

Thus, when the nano-texture is on one of the main faces of the plate 2, for example on the upper face 3, bending in the Z+ direction will cause tensioning of the nano-textures and bending in the direction Z− (as illustrated in FIG. 5) will cause compression of the nano-textures.

In the literature (document [2]), the interactions between two types of nano-pillars and two types of different bacteria have been studied. The conducted works show that nano-pillars with a 270×270 nm² (length (L)×width (I)) square section, having a height (h) of 220 nm and with a spacing of 220 nm between the nano-pillars, have an anti-fouling (i.e. repellent) action for the bacterium Staphylococcus Aureus, which is spherical and has a diameter of about 600 nm. These same nano-pillars are bactericidal (i.e. they kill) for the bacterium Escherichia coli, which is stick-shaped and with dimensions 900×2,000 nm (diameter×length). Thus, depending on the size ratio between the nano-pillars and the bacteria, we observe different effects:
the small nano-pillars (for example with dimensions 270×270×220 nm³ (L×I×h) with a spacing of 220 nm) are anti-fouling for the small bacterium S. Aureus and are bactericidal for the large bacterium E. Coli (bactericidal effect by piercing the membrane);
the small nano-pillars can repel the large bacteria without killing them (anti-fouling effect by reducing the adhesion surface of the bacteria);
the large nano-pillars (for example with dimensions 370×370×800 nm³ (L×I×h) with a spacing of 730 nm) can push the large bacteria without killing them (anti-fouling effect by reducing the adhesion surface of the bacteria);
the nano-pillars will force the bacteria to fit between them if the spacing of the nano-pillars is larger than the dimensions of the bacteria (patterning effect).

Based on these results, it is advantageous to estimate the minimum dimensions that nano-pillars should have to affect all of the bacteria of the marine environment.

Scientific works (document [3]) show that the marine bacteria and the unicellular prokaryotic plankton are among the smallest autonomous organisms of the sea; they measure at most 500 to 1,000 nanometres.

Other scientific works (document [4]) show that osmo-heterotrophic bacteria are the smallest unicellular living organisms in the oceans, and that they measure from 100 nm to 1 μm maximum.

From these different publications, we can deduce the dimensions of the nano-pillars that could act on the smallest bacteria of the marine environment. Thus, nano-pillars with a 45×45×36 nm³ (L×I×h) square section with a spacing of 36 nm will have an anti-fouling action for the smallest bacteria present in the marine environment (which measure about 100 nm). Moreover, it should be noted that the height of these pillars can impact the anti-fouling effect of these. The height of the nano-pillars can be increased without a problem by several micrometres for the pili of the bacteria to no longer be able to touch the surface at the base of the pillars. For example, it is possible to have 40×40×1,000 nm³; 40 nm (L×I×h; spacing) nano-pillars. On the other hand, the nano-pillars should have a minimum height, in order to make the surface heterogeneous at the scale of the marine microorganisms and therefore unsuitable for adhesion thereof. Indeed, thanks to these nano-pillars, some pili will touch the top of the nano-pillars, others will touch the column of the nano-pillars and others the surface at the base of the nano-pillars. This will show the bacterium that the surface is unsuitable for adhesion. Hence, the nano-pillars allow making the surface heterogeneous, in addition to reducing the adhesion surface available for the marine microorganisms; this results in an improved anti-fouling effect. Thus, we can deduce from these works and these reflections that static nano-pillars with a 40 nm side square section, spaced apart by 40 nm and having a minimum height of 50 nm (i.e. 40×40×50 nm³; 40 nm (I×I×h; spacing)) have at minimum an anti-fouling action on all bacteria of the marine environment, and could have a bactericidal action for the largest ones among them.

To study the behaviour of the pillars when the plate 2 is vibrating, we use the finite-element method (FEM, standing for “Finite Element Method” in English) using the COMSOL Multiphysics™ software. This software allows modelling a system with a nano-textured vibrating plate according to the invention, composed of a plate 2 made of PDMS having two main faces, one of these faces being nano-textured by nano-pillars 6, and the plate being vibrated by actuating two piezoelectric actuators 5 made of PZT arranged on the other main face. The system thus modelled is illustrated in FIG. 6. It is specified that the actuator(s) could be on the same face as the nano-texture. But, in this case, they will be in contact with the liquid, and even though they are passivated, there is a risk of failure. Hence, it is preferable that they are located on the face opposite to that comprising the nano-texture.

We will study three areas of the upper face 3 of the plate on this model, a central area 8 and two lateral areas 9, located on either side of the central area (FIG. 6).

In this model, the plate 2 measures 2 cm long, 0.5 cm wide and has a thickness of 100 μm; the nano-pillars 6 have a square section and measure 40×40×1,000 nm³ (L×I×h), for a spacing of 40 nm, i.e. the minimum dimensions in width, length and spacing calculated before, and are present over the entirety of the nano-textured main face.

At rest (FIG. 6), the spacing between the nano-pillars is 40 nm.

This system resonates at a frequency of 104,24 Hz and, under an actuation voltage of +10 V, the amplitude of deformation at this frequency is about 28 μm. We read the distance between the nano-pillars during operation at −10 V and at +10 V, in order to see the case where the nano-textured face of the plate is in compression and that where it is energised. More specifically, by operating at −10 V, the upper face (that which is nano-textured) is compressed, and therefore the nano-pillars are brought close to one another. By operating at +10 V, the upper face is pulled, and therefore the nano-pillars are brought away from one another.

We notice that the distances between the nano-pillars (i.e. the distance considered between the closest vertices of two adjacent pillars) during operation are different from those observed at rest. The results are compiled in Table 1 hereinbelow.

| | Spacing between the nano-pillars | | |
|---|---|---|---|
| | In the central | In the lateral | Maximum % of |
| | area (nm) | areas (nm) | movement |
| At rest | 40 | 40 | 0 |
| Activation at −10 V | 39.57 | 39.94 | 1% |
| (compression) | | | |
| Activation at +10 V | 40.24 | 40.40 | 1% |
| (tension) | | | |

A movement of the nano-texture in the range of one percent will have an anti-fouling effect:
this movement can kill the bacteria by piercing their membrane (bactericidal effect) when the stress exerted by the nano-texture on the bacterium is sufficient. Nano-textures in motion will naturally pierce the membranes of the bacteria more easily;
as already explained, the bacteria stick to the surfaces using their flagella, their pili or their curli. When they face a moving nano-texture, the anchor points are more rare and the adhesion of the bacteria is reduced (anti-fouling effect).

Thus, we have demonstrated that the vibration of the plate, which itself causes an anti-fouling effect, will set the pillars in movement, which will enhance this second anti-fouling effect of the nano-texture, for an optimised anti-fouling system. It should be noted that the nano-texture may be uniform or not (same dimensions or not), regular or not (same spacing or not) and arranged in area(s) or over the entire surface of the plate.

As we have just seen, the vibration of the plate can enhance the anti-fouling effect of the nano-texture.

It is also possible to use a structuring of the plate in order to increase the amplitude of vibration of the plate and therefore to enhance the anti-fouling effect of the vibration (the greater the amplitude of vibration, the more this vibration will have a pronounced anti-fouling effect).

For this purpose, a sufficiently large texture should be considered, in this case a micro-texture. The positioning of the micro-texture may be any one, but it will have more effect if it is positioned at strategic locations of the plate in order to increase the amplitude of vibration. For example, these strategic locations are the areas that will have the greatest stresses within the plate during vibration thereof, i.e. at the periphery of the plate, proximate to the areas for fastening or embedding the plate, in order to soften the plate, or proximate to the points of inflection of the deformation of the plate, in order to facilitate deformation thereof. For example, in the case of a plate with a circular shape and with a groove-type micro-texture, the grooves will ideally be circular and concentric and arranged parallel to the embedded areas. It should be noted that the increase in the amplitudes of vibration will increase the movement of the nano-texture on the plate, which will further improve the bactericidal and anti-fouling effect of these, and therefore of the system. The micro-texture is obtained by one or more element(s) formed recessed in the plate and with micrometric sizes. For example, these may consist of grooves.

To study the effects of the micro-texture of the plate on the amplitude of vibration of the plate, we use the COMSOL Multiphysics™ software again. We resume the previous models by adding a micro-texture 7 to the nano-textured vibrating system 1 composed of a PDMS plate 2 nano-textured by nano-pillars, the whole actuated by two piezoelectric actuators 5 made of PZT, the micro-texture 7 being obtained by recessing two grooves with a 500 μm width positioned parallel to one another, parallel to the actuators and which extend parallel to two opposite edges of the plate at equal distances from their respective edge. In this example, the length of each groove 7 is equal to the width of the plate (FIG. 7).

In this model, the plate of the system measures 2 cm long, 0.5 cm wide and 200 μm thick; the nano-pillars have a square section and measure 980×980×20,000 nm³ (L×I×h) for a spacing of 980 nm).

We actuate the vibration of the plate 2 by applying a +10 V voltage, for depths of micro-texturing grooves of different depths (the two grooves being, nonetheless, always identical), and we read each time the distance between the nano-pillars 6. The results are grouped together in Table 2 hereinbelow.

| | | | | Spacing between the nano- | |
|---|---|---|---|---|---|
| Micro- | Micro- | | | pillars | |
| texture | texture | Resonance | Maximum | In the | In the |
| width | depth | frequency | deformation | central area | lateral areas |
| (μm) | (μm) | (Hz) | (μm) | (nm) | (nm) |
| 0 | 0 | 395.65 | 22.66 | 987.00 | 993.80 |
| 500 | 50 | 396.22 | 22.77 | 987.30 | 994.38 |
| | 100 | 396.8 | 22.91 | 988.04 | 994.92 |
| | 150 | 397.4 | 23.04 | 988.98 | 998.20 |

It should be noticed that the micro-textures 7 could increase the amplitude of the vibrations of the anti-fouling system. In this case, the deeper the micro-textures, the more the amplitude of the vibrations of the system increases, which has the effect of increasing the distance between the nano-textures (i.e. the micro-textures increase the movement of the nano-textures), which further improves the anti-fouling and/or bactericidal effect of the final anti-fouling system.

Finally, the anti-fouling system according to the invention has many advantages:
the anti-fouling system according to the invention is a combination of two distinct anti-fouling technologies, but the anti-fouling technology by vibrating systems allows setting the anti-fouling technology by nano-textures into movement; the final result is an improved anti-fouling system, compared to the two technologies considered independently;
the nano-textures are effective against the smallest bacteria of the marine system, but are also effective against the largest bacteria;
the nano-textures may be uniform and regular, or have varied sizes and arranged irregularly if this could help fight some marine organisms, or if this is more effective to fight all marine bacteria;
the plate of this anti-fouling system may be manufactured in any material type, as long as it is possible to form nano-textures at the surface;
the plate presented in the model is rectangular, but it may have another shape where necessary, for example circular;
the use of this nano-textured vibrating system prevents the installation of biofouling, but could possibly destroy an already existing one by generating cavitations by vibrations;
microelectronics technologies allow using reduced thicknesses of active materials to make the actuators; the energy consumptions are therefore lowered, irrespective of the nature of the used actuators;
in the case of use of PZT-type piezoelectric actuators, piezoelectric ceramics allow having reliable and durable electromechanical systems, not subject to polarisation loss.

In addition, we can combine the anti-fouling system according to the invention with a chemical coating having anti-fouling properties. In this case, in order not to make the relief formed by the pillars disappear, the anti-fouling coating should be deposited in one or more layer(s) that is/are thin enough not to completely fill the spacing between the nano-pillars. The chemical coating may be an FRC release film. As explained in the prior art part, the FRC coatings reduce the adhesion forces of biofouling on the substrate, enabling a facilitated cleaning of the fouled support. The FRC release film may be obtained by vaporisation of fluorinated molecules on the nano-textured surface of the vibrating system, or by application of a layer of a commercial FRC paint over the vibrating system, by performing a pressure bath or a spin-coating step. The anti-fouling chemical coating may also be a coating loaded with biocides, which will be progressively released in order to confer a desired chemical anti-fouling effect on the final system. Such a coating may be applied using a commercial anti-fouling paint loaded with biocides, by performing a pressure bath or a spin-coating step. Also, with microelectronics technologies, it is possible to deposit one or more layer(s) of copper (a naturally anti-fouling material) in thin layers over the nano-textured surface of the system. If the vibrating system according to the invention is coated with a layer which is chemically anti-fouling, its surface will feature improved anti-fouling properties compared to the same system without chemical coating. More generally, any surface treatment allowing reducing the adhesion of biofouling on a surface may be combined with our nano-textured, and possibly micro-textured, vibrating plate system in order to obtain an improved anti-fouling effect, provided that the surface treatment does not make the nano-texture disappear.

### CITED REFERENCES

[1] M. Rahmoune, M. Latour, “Application of Mechanical Waves Induced by Piezofilms to Marine Fouling Prevention”, Journal of Intelligent Material Systems and Structures, Vol.

7, January 1996
[2] T. S. Heckmann, J. D. Schiffman, “Spatially Organised Nanopillar Arrays Dissimilarly Affect the Antifouling and Antibacterial Activities of Escherichia coli and Staphylococcus aureus”, ACS Applied Nano Material, pages 977-984 (2020)
[3] H. W. Ducklow, “Bacterioplankton”, article in the 1^{st} edition of Encyclopedia of Ocean Sciences, volume 1, pp 217-224 (2001)
[4] K. H. Andersen et al., “Characteristic sizes of life in the oceans, from bacteria to whales”, Annual Review of Marine Science (2015)

1. An anti-biofouling system configured to be attached on a device having a fouling-sensitive element and which is configured to be immersed in a liquid, the anti-biofouling system being configured to at least partially cover the fouling-sensitive element, the anti-biofouling system comprising:
a plate extending in a plane XY and having two opposite main faces, one of which is configured to be in contact with the liquid; and
at least one actuator able to deform the plate off its plane, the at least one actuator located on one of the main faces of the plate;
wherein the plate includes a nano-texture over all or part of the main face configured to be in contact with the liquid,
wherein the nano-texture is formed by a plurality of elements raised with respect to a surface of the plate, each raised element having at least two dimensions of 1 nm to 1,000 nm exclusive, and
wherein at least over an area of the nano-textured face the raised elements are spaced apart from each other by 1 nm to 1,000 nm.

2. The anti-biofouling system of claim 1, wherein the raised elements are pillars comprising a section with dimensions of 1 nm to 1,000 nm.

3. The anti-biofouling system of claim 1, wherein the raised elements have at least one dimension greater than or equal to 40 nm, and
wherein a spacing between the raised elements is greater than or equal to 40 nm.

4. The anti-biofouling system of claim 1, wherein the at least one actuator and the nano-texture are on distinct main faces.

5. The anti-biofouling system of claim 1, wherein the plate is rectangular, and
wherein the at least one actuator is arranged parallel to two opposite edges of the plate.

6. The anti-biofouling system of claim 1, wherein one main face of the plate includes a micro-texture formed by at least one element recessed with respect to a surface of the plate, the recessed element having at least two dimensions out of three which are 1 μm to 1,000 μm.

7. The anti-biofouling system of claim 1, wherein the at least one actuator is a piezoelectric actuator.

8. The anti-biofouling system of claim 1, wherein the face of the plate including the nano-texture and the raised elements is coated with a chemical coating having anti-fouling properties.

9. An assembly comprising a device, the device comprising:
a fouling-sensitive element; and
the anti-biofouling system of claim 1,
wherein the anti-biofouling system is attached on the device so as to at least partially cover the fouling-sensitive element, and
wherein the device is a sensor-type control device.
